(19) United States
(12) Patent Application Publication
(10) Pub. No.: US 2018/0009264 A1
(43) Pub. Date: Jan. 11, 2018

(54) GLASS-RESIN MULTICOMPOSITE REINFORCEMENT WITH IMPROVED PROPERTIES

(71) Applicants: COMPAGNIE GENERALE DES ETABLISSEMENTS MICHELIN, CLERMONT-FERRAND (FR); Michelin Recherche et Technique S.A., GRANGES-PACCOT (FR)

(72) Inventor: ANTONIO DELFINO, Clermont-Ferrand (FR)

(21) Appl. No.: 15/545,160

(22) PCT Filed: Jan. 19, 2016
(86) PCT No.: PCT/EP2016/051033

§ 371 Date: Jul. 20, 2017

(30) Foreign Application Priority Data
Jan. 21, 2015 (FR) 1550455

(51) Int. Cl. B60C 9/00; D02G 3/18; D02G 3/48

(52) U.S. Cl. CPC B60C 9/0028; D02G 3/48; D02G 3/18; B60C 2009/0078

(57) ABSTRACT

A multicomposite reinforcer (R1, R2) comprises one or more monofilament(s) (10) made of glass-resin composite comprising glass filaments (101) embedded in a crosslinked resin (102), with a glass transition temperature Tg₁. A layer of a thermoplastic material (12), the glass transition temperature of which, denoted Tg₂, is greater than 20° C., covers said monofilament or, if there are several, individually covers each monofilament or collectively covers all or at least some of the monofilaments. Said monofilament or, if there are several, all or at least some of the monofilaments has the following features: a temperature Tg₁ equal to or greater than 190° C.; an elongation at break A_{(M)} equal to or greater than 4.0%; and an initial tensile modulus E_{(M)} greater than 35 GPa. A multilayer laminate may comprise such a multicomposite reinforcer. A pneumatic or non-pneumatic tyre may be reinforced with such a multicomposite reinforcer or multilayer laminate.

### 1. FIELD OF THE INVENTION

The field of the present invention is that of composite reinforcers and multilayer laminates which may be used especially for reinforcing semi-finished products or finished articles made of rubber such as vehicle tyres of the pneumatic or non-pneumatic type.

It more particularly relates to composite reinforcers based on monofilaments of the “GRC” type (abbreviation for glass-resin composite) with high mechanical and thermal properties comprising continuous unidirectional multifilament glass fibres embedded in a crosslinked resin and which can be used in particular as reinforcing elements for these tyres.

### 2. PRIOR ART

Tyre designers have long sought low density textile or composite type “reinforcers” (elongate reinforcing elements) which could advantageously and effectively replace the conventional metal wires or cords, with a view to reducing especially the weight of these tyres and also to remedying any problems of corrosion.

Thus, patent EP 1 167 080 (or U.S. Pat. No. 7,032,637) has already described a GRC monofilament with high mechanical properties, comprising continuous unidirectional glass fibres, impregnated in a crosslinked resin of vinyl ester type. As well as a high breaking stress in compression which is greater than its breaking stress in extension, this GRC monofilament has an elongation at break of the order of 3.0 to 3.5% and an initial tensile modulus of at least 30 GPa; its crosslinked resin has a Tg (glass transition temperature) of greater than 130° C. and an initial tensile modulus of at least 3 GPa.

By virtue of the above properties, this patent EP 1 167 080 showed that it was advantageously possible to replace steel cords with such GRC monofilaments, positioned in particular under the tread in parallel sections, as novel reinforcing elements for pneumatic tyre belts, thereby making it possible to significantly lighten the structure of the tyres.

Experience has shown, nonetheless, that the GRC monofilaments described in the above patents can be further improved, in particular for their use in vehicle tyres.

In particular it was noted, unexpectedly, that these GRC monofilaments of the prior art, when they were used as belt reinforcers for certain pneumatic tyres, could undergo a certain number of breakages in compression by a visible collapse of their structure during the very manufacturing of these tyres, more specifically during the shaping step and/or the final step of curing these tyres in a mould which, as is known, is carried out at high pressure and a very high temperature, typically of greater than 160° C.

### 3. BRIEF DESCRIPTION OF THE INVENTION

Now, continuing their research studies, the Applicant companies have discovered a novel multicomposite reinforcer, based on GRC monofilaments with improved glass transition temperature, elongation at break and modulus properties, furthermore that are sheathed with a layer of thermoplastic material, which give this reinforcer properties in compression, bending or under transverse shear (perpendicular to the axis of the reinforcer) which are significantly improved, in particular at high temperature (typically greater than 150° C.), relative to those of the GRC monofilaments of the prior art.

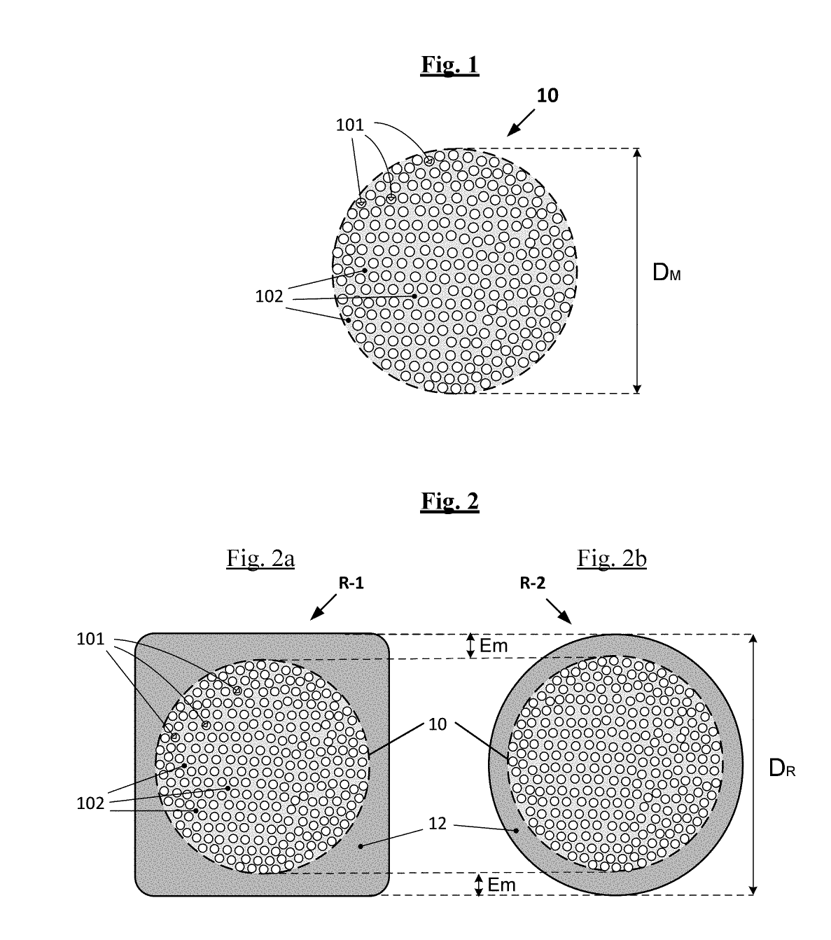

Thus, according to a first subject, the present invention relates (in reference to the appended FIGS. 1 and 2) to a multicomposite reinforcer (R1, R2) comprising one or more monofilament(s) (10) made of glass-fibre-reinforced polymer comprising glass filaments (101) embedded in a crosslinked resin (102), the glass transition temperature of which is denoted Tg₁, said multicomposite reinforcer being characterized in that:
a layer of a thermoplastic material (12), the glass transition temperature of which, denoted Tg₂, is greater than 20° C., covers said monofilament or, if there are several, individually covers each monofilament or collectively covers all or at least some of the monofilaments;
said monofilament or, if there are several, all or at least some of the monofilaments has the following features:
   a temperature Tg₁ equal to or greater than 190° C.;
   an elongation at break, denoted A_{(M)}, measured at 20° C., equal to or greater than 4.0%;
   an initial tensile modulus, denoted E_{(M)}, measured at 20° C., greater than 35 GPa.

The thermoplastic, and therefore thermofusible, nature of the material covering the GRC monofilaments very advantageously makes it possible, moreover, to manufacture in a way by “thermal bonding or assembly” a wide variety of multicomposite reinforcers (containing several filaments) having various shapes and cross sections, this by at least partial melting of the covering material, then cooling of all of the filaments sheathed in thermoplastic material once the latter have been placed together, arranged in an appropriate manner.

The invention also relates to any multilayer laminate comprising at least one multicomposite reinforcer according to the invention, positioned between and in contact with two layers of rubber, especially diene rubber, composition.

The invention also relates to the use of a multicomposite reinforcer or multilayer laminate according to the invention, as reinforcing element for articles or semi-finished products made of plastic or of rubber such as hoses, drive belts, conveyor belts, pneumatic or non-pneumatic tyres for vehicles, and also these articles, semi-finished products and tyres themselves, both in the raw state (that is to say before curing or vulcanization) and in the cured state (after curing).

The tyres of the invention, in particular, may be intended for motor vehicles of the passenger, 4×4 or “SUV” (Sport Utility Vehicle) type, but also for industrial vehicles chosen from vans, “heavy” vehicles—i.e., underground trains, buses, heavy road transport vehicles (lorries, towing vehicles, trailers), off-road vehicles—agricultural or civil engineering machines, aircraft and other transport or handling utility vehicles.

The multicomposite reinforcer and multilayer laminate of the invention can most particularly be used as reinforcing elements in crown reinforcements (or belts) or in carcass reinforcements of tyres, as described especially in the aforementioned documents EP 1 167 080 or U.S. Pat. No. 7,032,637. They could also be present in the bead zone of such tyres.

The multicomposite reinforcer of the invention can also advantageously be used, due to its low density and its properties in compression, bending and under transverse shear which are improved, as a reinforcing element in tyres or flexible wheels of non-pneumatic type, that is to say which are structurally supported (without internal pressure). Such tyres or wheels are well known to those skilled in the art, reference may be made, in particular, to the patent documents EP 1 242 254 or U.S. Pat. No. 6,769,465, EP 1 359 028 or U.S. Pat. No. 6,994,135, EP 1 242 254 or U.S. Pat. No. 6,769,465, U.S. Pat. No. 7,201,194, WO 00/37269 or U.S. Pat. No. 6,640,859, WO 2007/085414, WO 2008/080535, WO 2009/033620, WO 2009/135561, WO 2012/032000, likewise to the publication “Development of a Non Pneumatic Wheel”, T. B. Rhyne and S. M. Cron, Tire Science and Technology, TSTCA, Vol. 34, No. 3, July-September 2006, pp. 150-169; when they are combined with any rigid mechanical element intended to create the link between the flexible tyre and the hub of a wheel, they replace the assembly made up of the pneumatic tyre, the wheel rim and the disc as they are known in the majority of contemporary road vehicles. The multicomposite reinforcer of the invention can in particular be advantageously used in the annular shear layers or bands forming the belt of such tyres.

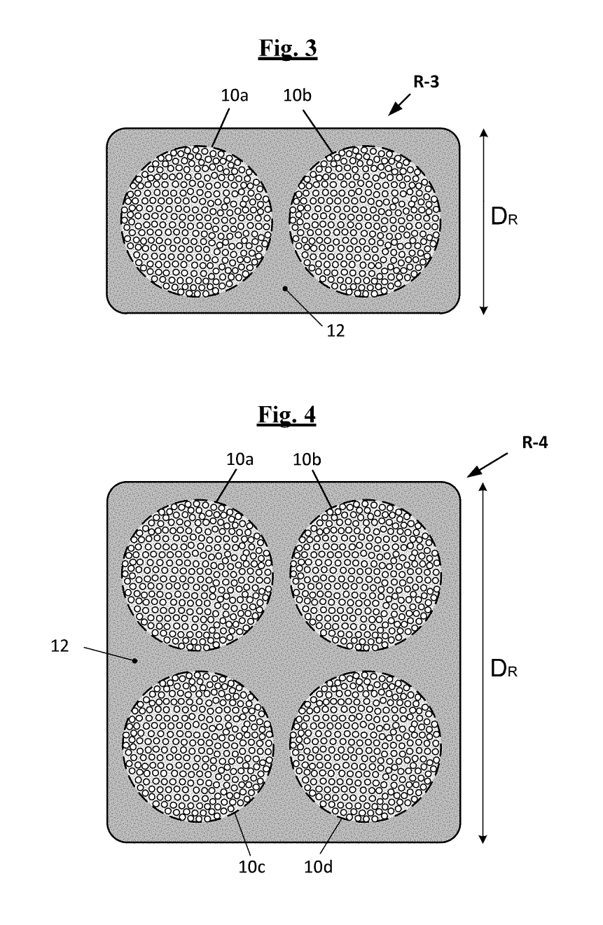

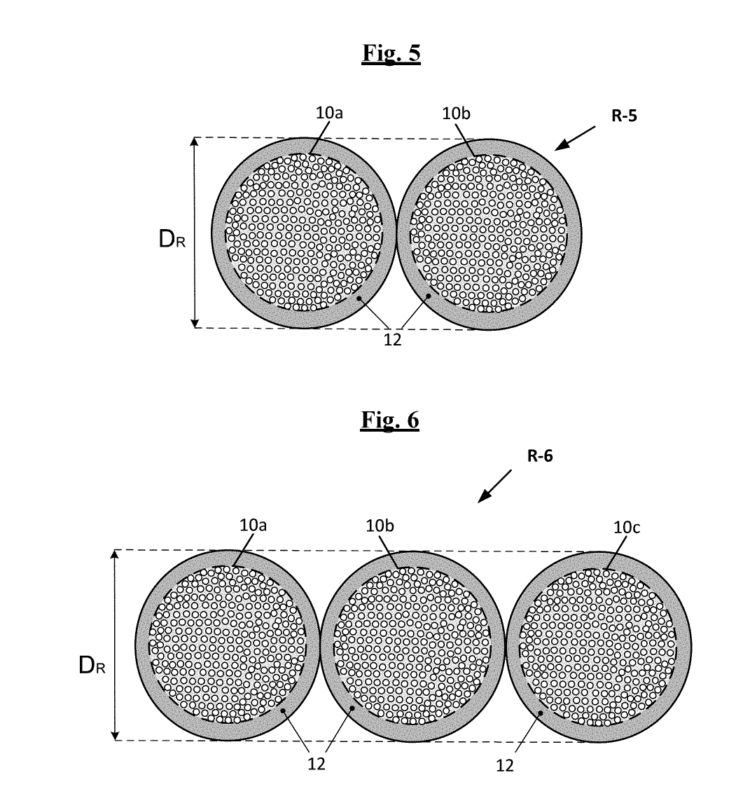

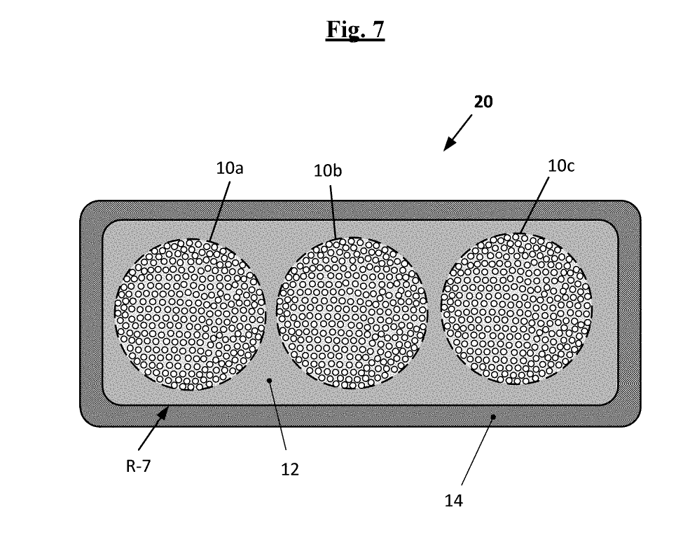

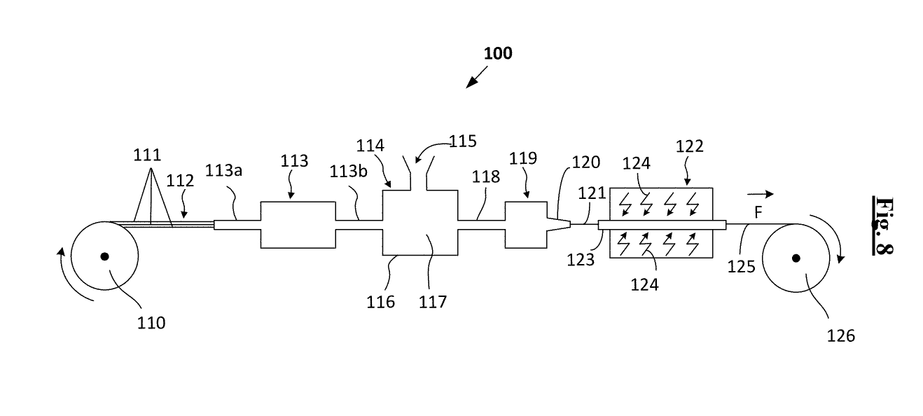

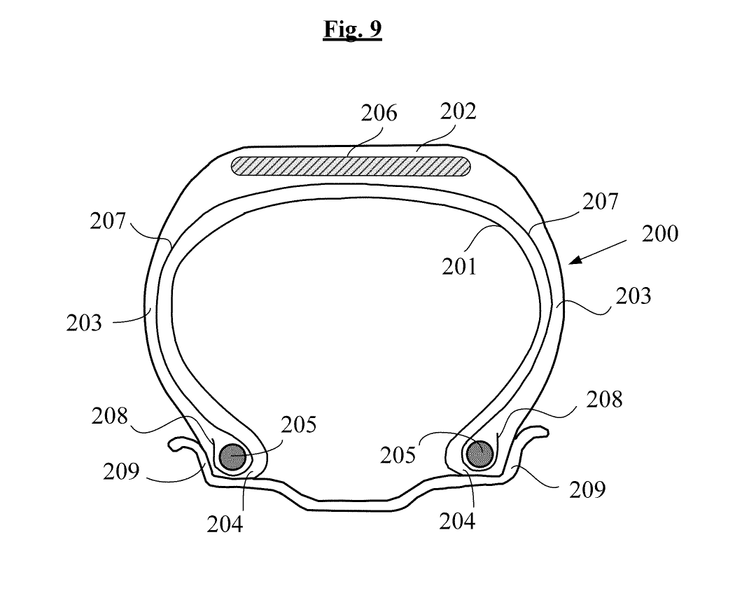

The invention and the advantages thereof will be readily understood in light of the following detailed description and exemplary embodiments, and also FIGS. 1 to 9 which relate to these examples and which schematically depict (without being true to scale):
in cross section, a GRC monofilament (10) that can be used in a multicomposite reinforcer in accordance with the invention (FIG. 1);
in cross section, two examples (R-1 and R-2) of multicomposite reinforcers in accordance with the invention (FIG. 2a and FIG. 2b);
in cross section, another example (R-3) of a multicomposite reinforcer in accordance with the invention (FIG. 3);
in cross section, another example (R-4) of a multicomposite reinforcer in accordance with the invention (FIG. 4);
in cross section, another example (R-5) of a multicomposite reinforcer in accordance with the invention (FIG. 5);
in cross section, another example (R-6) of a multicomposite reinforcer in accordance with the invention (FIG. 6);
in cross section, an example (20) of a multilayer laminate according to the invention comprising a multicomposite reinforcer according to the invention (R-7) itself embedded in a diene rubber matrix (FIG. 7);
a device that can be used for the manufacture of a GRC monofilament (10) that can be used as a base constituent element of a multicomposite reinforcer according to the invention (FIG. 8);
in radial section, an example of a pneumatic tyre according to the invention, incorporating a multicomposite reinforcer and a multilayer laminate according to the invention (FIG. 9).

### 4. DETAILED DESCRIPTION OF THE INVENTION

In the present application, unless expressly indicated otherwise, all the percentages (%) shown are percentages by weight.

Any range of values denoted by the expression “between a and b” represents the field of values ranging from more than a to less than b (that is to say limits a and b excluded) whereas any range of values denoted by the expression “from a to b” means the field of values ranging from a up to b (that is to say including the strict limits a and b).

The invention therefore relates to a reinforcer of multicomposite type, in other words a composite, that can be used in particular for reinforcing rubber articles such as tyres for vehicles, which has the essential feature of comprising at least, first of all one monofilament or several monofilaments (10) made of GRC as depicted in FIG. 1, comprising glass filaments (101) embedded in a crosslinked resin (102), the glass transition temperature of which is denoted Tg₁, said monofilament or, if there are several, all or at least some of the monofilaments, having the following essential features:
a temperature Tg₁ equal to or greater than 190° C.;
an elongation at break A_{(M)}, measured at 20° C., equal to or greater than 4.0%; and
an initial tensile modulus E_{(M)}, measured at 20° C., greater than 35 GPa.

Typically, the glass filaments are present in the form of a single multifilament fibre or several multifilament fibres (if there are several, they are preferably essentially unidirectional), each of them being able to comprise several tens, hundreds or even thousands of unitary glass filaments. These very fine unitary filaments generally, and preferably, have a mean diameter of the order of 5 to 30 μm, more preferably from 10 to 20 μm.

The term “resin” or “crosslinked resin” here is intended to mean the resin in unmodified form and any composition based on this resin and comprising at least one additive (that is to say one or more additives). This resin is, of course, cured (for example photocured and/or thermoset), in other words in the form of a network of three-dimensional bonds, in a state specific to “thermosetting” polymers (as opposed to “thermoplastic” polymers).

The temperature Tg₁ is preferably greater than 195° C., more preferentially greater than 200° C. It is measured (like Tg₂ and Tm described below) in a known manner by DSC (Differential Scanning calorimetry), at the second pass, for example, and unless otherwise indicated in the present application, according to standard ASTM D3418 of 1999 (“822-2” DSC apparatus from Mettler Toledo; nitrogen atmosphere; samples first brought from ambient temperature (23° C.) to 250° C. (10° C./min), then rapidly cooled down to 23° C., before final recording of the DSC curve from 23° C. up to 250° C., at a ramp of 10° C./min).

The elongation at break A_{(M)} of the monofilament or, if there are several, of all or at least some (preferably the majority, i.e. by definition the majority by number) of the monofilaments, is preferably greater than 4.2%, more preferentially greater than 4.4%. The initial tensile modulus E_{(M)} of the monofilament or, if there are several, of all or at least some (preferably the majority) of the monofilaments, is preferably greater than 40 GPa, more preferentially greater than 42 GPa.

The tensile mechanical properties (modulus E and elongation at break A) are measured in a known manner using an “Instron” 4466 type tensile testing machine (BLUEHILL-2 software supplied with the tensile testing machine), according to standard ASTM D 638, on GRC monofilaments or multicomposite reinforcers as manufactured, that is to say which have not been sized, or else sized (that is to say ready to use), or else extracted from the semi-finished product or from the article made of rubber that they reinforce. Before measurement, these monofilaments or these multicomposite reinforcers are subjected to prior conditioning (storage for at least 24 hours in a standard atmosphere in accordance with European Standard DIN EN 20139 (temperature of 23±2° C.; relative humidity of 50±5%). The samples tested are subjected to a tensile stress over an initial length of 400 mm at a nominal speed of 100 m/min, under a standard pretension of 0.5 cN/tex. All the results given are an average over 10 measurements.

According to another preferred embodiment, for an improved compromise between thermal and mechanical properties of the reinforcer of the invention, the real part of the complex modulus, denoted E′_{190(M)}, of the monofilament or, if there are several, of all or at least some (preferably the majority) of the monofilaments, measured at 190° C. by the DMTA method, is greater than 30 GPa. E′_{190(M)} is more preferentially greater than 33 GPa, more preferentially still greater than 36 GPa.

According to one particularly preferred embodiment, in the case where several monofilaments are present in the multicomposite reinforcer of the invention, each of the monofilaments has the essential features of Tg₁, A_{(M)} and E_{(M)} as mentioned above; more preferentially, each of them has the preferential features, in particular more preferential features, of Tg₁, A_{(M)}, E_{(M)} and E′_{190(M)} as mentioned above.

According to another preferred embodiment, for an optimized compromise between thermal and mechanical properties of the reinforcer of the invention, the ratio E′_{(Tg2′-25)(M)}/E′_{20(M)} is greater than 0.85, preferably greater than 0.90; E′_{20(M)} and E′_{(Tg2′-25)(M)} represent the real part of the complex modulus of the monofilament, measured by DMTA, respectively at 20° C. and at a temperature expressed in ° C. equal to (Tg₂′−25), in which expression Tg₂′ represents the glass transition temperature (Tg) measured this time by DMTA.

According to another more preferred embodiment, the ratio E′_{(Tg2′-10)(M)}/E′_{20(M)} is greater than 0.80, preferably greater than 0.85, E′_{(Tg2′-10)(M)} being the real part of the complex modulus of the monofilament measured by DMTA at a temperature in ° C. equal to (Tg₂′−10).

The measurements of E′ and Tg₂′ are carried out in a known manner by DMTA (“Dynamic Mechanical Thermal Analysis”), with a “DMA⁺450” viscosity analyser from ACOEM (France), using the “Dynatest 6.83/2010” software to control the bending, tensile or torsion tests.

According to this device, since the three-point bending test does not make it possible in a known manner to enter the initial geometric data for a monofilament of circular cross section, only the geometry of a rectangular (or square) cross section may be entered. In order to obtain a precise measurement of the modulus E′ for a monofilament of diameter here denoted D_{M} (see FIG. 1), the convention is therefore to introduce into the software a square cross section with a side length “a” having the same surface moment of inertia, so as to be able to work with the same stiffness R of the test specimens tested.

The following well-known relationships must apply (E being the modulus of the material, Iₛ the surface moment of inertia of the object in question, and * the multiplication symbol):

R=E_{composite}*I_{circular cross section}=E_{composite}*I_{square cross section} with:I_{circular cross section}=π*D_{M}⁴/64 and I_{square cross section}=a⁴/12

The value of the side length “a” of the equivalent square with the same surface inertia as that of the (circular) cross section of the monofilament of diameter D_{M} is easily deduced therefrom, according to the equation:

a=D_{M}*(π/6)^{0.25}.

In the event that the cross section of the sample tested is not circular (or rectangular), irrespective of the specific shape thereof, the same calculation method will be applied, with prior determination of the surface moment of inertia Iₛ on a cross section of the sample tested.

The test specimen to be tested, generally of circular cross section and of diameter D_{M}, has a length of 35 mm. It is arranged horizontally on two supports 24 mm apart from one another. A repeated bending stress is applied at right angles to the centre of the test specimen, halfway between the two supports, in the form of a vertical displacement with an amplitude equal to 0.1 mm (thus an asymmetrical deformation, the interior of the test specimen being stressed solely in compression and not in extension) at a frequency of 10 Hz.

The following programme is then applied: under this dynamic stress, the test specimen is gradually heated from 25° C. to 260° C. with a ramp of 2° C./min. At the end of the test, measurements of the elastic modulus E′, the viscous modulus E″ and the loss angle (δ) are obtained as a function of the temperature (where E′ is the real part and E″ the imaginary part of the complex modulus); Tg₂′ is the glass transition temperature corresponding to the maximum (peak) of tan(δ).

According to a preferred embodiment, the GRC monofilament or, if there are several, all or at least some (preferably the majority) of the GRC monofilaments, has a compressive elastic deformation in bending which is greater than 3.0%, more preferably greater than 3.5%, in particular greater than 4.0%; according to another preferred embodiment, their compressive breaking stress in bending is greater than 1000 MPa, more preferably greater than 1200 MPa, in particular greater than 1400 MPa.

The above compressive bending properties are measured on the GRC monofilament as described in the aforementioned document EP 1 167 080 by the method referred to as the loop test (D. Sinclair, J. App. Phys. 21, 380, 1950). In the present case, a loop is produced and is brought gradually to its breaking point. The nature of the break, which is readily observable due to the large size of the cross section, makes it immediately possible to realize that the monofilament, stressed in bending until it breaks, breaks on the side where the material is in extension, which can be identified by simple observation. Given that in this case the dimensions of the loop are large, it is possible at any time to read the radius of the circle inscribed in the loop. The radius of the circle inscribed just before the breaking point corresponds to the critical radius of curvature, denoted by Rc.

The following formula then makes it possible to determine, by calculation, the critical elastic deformation denoted Ec (where r corresponds to the radius of the monofilament, that is to say D_{M}/2):

Ec=r/(Rc+r)

The compressive breaking stress in bending, denoted σ_{c}, is obtained by calculation using the following formula (where E is the initial tensile modulus):

σ_{c}=Ec*E

When the loop breaks in the part in extension, it may be concluded therefrom that, in bending, the compressive breaking stress is greater than the tensile breaking stress.

Flexural breaking of a rectangular bar by the method referred to as the three-point method (ASTM D 790) may also be carried out. This method also makes it possible to verify, visually, that the nature of the break is indeed in extension.

According to a preferred embodiment, the breaking stress in pure compression is greater than 700 MPa, more preferably greater than 900 MPa, in particular greater than 1100 MPa. To avoid buckling of the GRC monofilament under compression, this magnitude is measured according to the method described in the publication “Critical compressive stress for continuous fiber unidirectional composites” by Thompson et al., Journal of Composite Materials, 46(26), 3231-3245.

Preferably, in each GRC monofilament or, if there are several, in all or at least some (preferably the majority) of the GRC monofilaments, the degree of alignment of the glass filaments is such that more than 85% (% by number) of the filaments have an inclination relative to the axis of the monofilament which is less than 2.0 degrees, more preferably less than 1.5 degrees, this inclination (or misalignment) being measured as described in the above publication by Thompson et al.

Preferably, in the multicomposite reinforcer of the invention, the GRC monofilament or, if there are several, all or at least some (preferably the majority) of the GRC monofilaments, has a weight content of glass fibres which is between 60% and 80%, more preferentially between 65% and 75%.

This weight content is calculated from the ratio of the count of the initial glass fibre to the count of the final GRC monofilament. The count (or linear density) is determined on at least three samples, each corresponding to a length of 50 m, by weighing this length; the count is given in tex (weight in grams of 1000 m of product—as a reminder, 0.111 tex is equal to 1 denier).

According to another preferred embodiment, in the multicomposite reinforcer of the invention, the GRC monofilament or, if there are several, all or at least some (preferably the majority) of the GRC monofilaments, has a density (in g/cm³) which is between 1.8 and 2.1. It is measured (at 23° C.) by means of a specialized balance from Mettler Toledo of the “PG503 DeltaRange” type; the samples, of a few cm, are successively weighed in air and immersed in ethanol, then the software of the apparatus determines the mean density over three measurements.

The diameter denoted D_{M} of the GRC monofilament, or each GRC monofilament if there are several, is preferably between 0.2 and 2.0 mm, more preferably between 0.3 and 1.5 mm.

This definition equally covers monofilaments of essentially cylindrical shape (with circular cross section) and monofilaments of other shapes, for example oblong monofilaments (with a more or less flattened shape) or of rectangular cross section. In the case of a non-circular cross section and unless specifically indicated otherwise, by convention D_{M} is the diameter known as clearance diameter, that is to say the diameter of the imaginary cylinder of revolution that surrounds the monofilament, in other words the diameter of the circumscribed circle surrounding its cross section.

The resin used is, by definition, a crosslinkable (i.e. curable) resin which is capable of being crosslinked, cured by any known method, in particular by UV (or UV-visible) radiation, preferably emitting in a spectrum ranging at least from 300 nm to 450 nm.

As crosslinkable resin, use is preferably made of a polyester or vinyl ester resin, more preferably a vinyl ester resin. The term “polyester” resin is intended to mean, in a known way, a resin of unsaturated polyester type. As for vinyl ester resins, they are well known in the field of composite materials.

Without this definition being limiting, the vinyl ester resin is preferably of the epoxy vinyl ester type. Use is more preferably made of a vinyl ester resin, in particular of the epoxide type, which, at least in part, is based on novolac (also known as phenoplast) and/or bisphenol (that is to say is grafted onto a structure of this type), or preferably a vinyl ester resin based on novolac, bisphenol, or novolac and bisphenol.

Preferably, the initial tensile modulus of the resin once it is thermoset (crosslinked), measured at 20° C., is greater than 3.0 GPa, more preferably greater than 3.5 GPa.

An epoxy vinyl ester resin based on novolac (the part between brackets in Formula I below) corresponds for example, in a known way, to the following Formula (I):

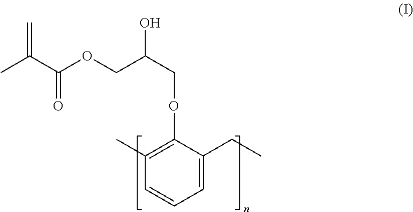

An epoxy vinyl ester resin based on bisphenol A (the part between brackets in Formula (II) below) corresponds for example to the formula (the “A” serving as a reminder that the product is manufactured using acetone):

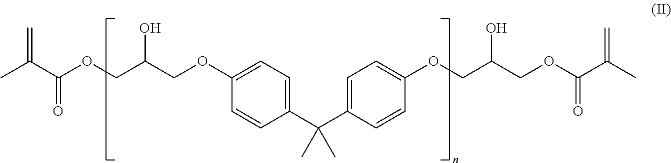

An epoxy vinyl ester resin of novolac and bisphenol type has demonstrated excellent results. By way of example of such a resin, mention may especially be made of the vinyl ester resins “Atlac 590” and “E-Nova FW 2045” from DSM (diluted with approximately 40% styrene) described, for example, in the applications EP-A-1 074 369 and EP-A-1 174 250. Epoxy vinyl ester resins are available from other manufacturers such as, for example, AOC (USA-“Vipel” resins).

According to another essential feature of the invention, as already indicated, a layer of a thermoplastic material (12) covers the GRC monofilament or, if there are several, individually covers each monofilament or collectively covers all or at least some (preferably the majority) of the monofilaments, in order to form the multicomposite reinforcer of the invention.

It was observed that the presence of this sheath or layer of thermoplastic material gave the GRC monofilaments, and thus the multicomposite reinforcer of the invention, properties of endurance in compression, bending or under transverse shear (perpendicular to the axis of the monofilament) which are significantly improved, in particular at a high temperature (typically greater than 150° C.), compared with those of the GRC monofilaments from the prior art.

The glass transition temperature Tg₂ of this thermoplastic material (12) is greater than 20° C., it is preferably greater than 50° C., more preferably greater than 70° C. Its melting temperature (denoted Tm) is preferably greater than 150° C., more preferably greater than 200° C.

Preferably, the minimal thickness (denoted Eₘ) as shown, for example, in FIG. 2, of the layer of thermoplastic material covering the monofilament or each monofilament if there are several, is between 0.05 and 0.5 mm, more preferably between 0.1 and 0.4 mm, in particular between 0.1 and 0.3 mm.

Preferably, since all the parameters below were measured at 20° C., the initial tensile modulus of this thermoplastic material (12) is between 500 and 2500 MPa, more preferably between 500 and 1500 MPa; its elastic elongation is preferably greater than 5%, more preferably greater than 8%, in particular greater than 10%; its elongation at break is preferably greater than 10%, more preferably greater than 15%, in particular greater than 20%.

Typically, the thermoplastic material is a polymer or a polymeric composition (i.e. a composition based on at least one polymer and on at least one additive).

This thermoplastic polymer is preferably selected from the group consisting of polyamides, polyesters and polyimides and mixtures of such polymers, more particularly from the group consisting of polyesters, polyetherimides and mixtures of such polymers.

Mention may in particular be made, among the aliphatic polyamides, of the polyamides PA-4,6, PA-6, PA-6,6, PA-11 or PA-12. The thermoplastic polymer is preferably a polyester; among the polyesters, mention may be made, more particularly, of PET (polyethylene terephthalate), PEN (polyethylene naphthalate), PBT (polybutylene terephthalate), PBN (polybutylene naphthalate), PPT (polypropylene terephthalate) and PPN (polypropylene naphthalate). According to another preferred embodiment, the thermoplastic polymer is a polyetherimide (PEI), for example the product “Ultem 1000” from GE Plastics.

Various additives such as a dye, filler, plasticizer, antioxidant or other stabilizer may be optionally added to the above polymer or mixture of polymers in order to form a polymeric composition. Compatible components, preferably themselves thermoplastic, capable of promoting the adhesion to a diene rubber matrix, for example TPS (thermoplastic styrene) elastomers of unsaturated type, especially that are epoxidized, as described for example in applications WO 2013/117474 and WO 2013/117475, could advantageously be added to the above thermoplastic material.

The elongation at break denoted A_{(R)}, measured at 20° C., of the multicomposite reinforcer of the invention is preferably equal to or greater than 3.0%, more preferably equal to or greater than 3.5%. Its initial tensile modulus denoted E_{(R)}, measured at 20° C., is preferably greater than 9 GPa, more preferably greater than 12 GPa.

FIG. 2 depicts, in cross section, two examples (R-1 and R-2) of multicomposite reinforcers in accordance with the invention, in which a single GRC monofilament (10) as described above, for example having a diameter D_{M} equal to 1 mm, was covered by its layer or sheath of thermoplastic material, for example made of polyester, for instance PET, having a minimal thickness denoted Eₘ (for example equal to around 0.2 mm); in these two examples, the cross section of the multicomposite reinforcer is either rectangular (here essentially square) or circular (respectively FIG. 2a and FIG. 2b).

The diameter (for FIG. 2a) or the thickness (for FIG. 2b) denoted D_{R} of these reinforcers R-1 and R-2 of the invention, equal to D_{M}+2 Eₘ, is therefore around 1.4 mm in these two examples.

Owing to the combined presence of its glass filaments (101), its crosslinked matrix (102) and the thermoplastic sheath (12) fulfilling in a way a hooping function of the GRC monofilament (10), the multicomposite reinforcer of the invention (R-1, R-2) is characterized by an improved transverse cohesion, and a high dimensional, mechanical and thermal stability.

In the case where several GRC monofilaments are used, the thermoplastic layer or sheath may be deposited individually on each of the monofilaments as illustrated for example in FIGS. 2, 5 and 6, or else deposited collectively over several of the monofilaments positioned in an appropriate manner, for example aligned along a main direction, as illustrated for example in FIGS. 3, 4 and 7.

FIG. 3 depicts, in cross section, another example of a multicomposite reinforcer (R-3) in which two GRC monofilaments (10), substantially of the same diameter (for example equal to around 1 mm), have been covered together with a sheath of thermoplastic material (12), for example made of polyester, for instance PET, having a minimal thickness Eₘ (for example equal to around 0.25 mm). In these examples, the cross section of the multicomposite reinforcer is rectangular, having a thickness D_{R} equal to D_{M}+2 Eₘ, such as for example of the order of 1.5 mm.

FIG. 4 depicts, in cross section, another example of a multicomposite reinforcer (R-4) in which four GRC monofilaments (10), substantially of the same diameter (for example equal to around 0.5 mm), have been covered together with a sheath of thermoplastic material, for example made of polyester, for instance PET, in order to form a multicomposite reinforcer of substantially square cross section, of thickness D_{R}.

The thermoplastic, and therefore thermofusible, nature of the material (12) covering each GRC filament (10) very advantageously makes it possible to manufacture, by thermal bonding, a wide variety of multicomposite reinforcers containing several filaments, having various shapes and cross sections, this by at least partial melting of the covering material, then cooling of all of the filaments (10) sheathed in thermoplastic material (12) once the latter have been placed together, arranged in an appropriate manner. This at least partial melting will be carried out at a temperature preferably between the melting temperature Tm of the thermoplastic material (12) and the glass transition temperature Tg₂ of the crosslinked resin (102).

Thus, FIG. 5 depicts, in cross section, another example of a multicomposite reinforcer (R-5) according to the invention in which two individual multicomposite reinforcers R-2 as depicted in FIG. 2 (FIG. 2b) have been brought into contact, bonded, welded together by superficial melting of their thermoplastic sheath (12) followed by a cooling step in order to obtain this reinforcer R-5 of thickness D_{R}.

FIG. 6 reproduces another example of a multicomposite reinforcer according to the invention in which three individual multicomposite reinforcers R-2 as depicted in FIG. 2 (FIG. 2b) have been aligned, brought into contact, then bonded and welded together by superficial melting of their thermoplastic sheath (12) followed by cooling in order to obtain another multicomposite reinforcer (R-6) with a cross section of thickness D_{R}.

The invention also relates to a multilayer laminate comprising at least one multicomposite reinforcer according to the invention as described above, positioned between and in contact with two layers of rubber or elastomer, especially diene rubber or elastomer, composition.

In the present application, in a known manner, the following definitions apply:
“laminate” or “multilayer laminate”, within the meaning of the International Patent Classification: any product comprising at least two layers, of flat or non-flat form, which are in contact with one another, the latter possibly or possibly not being joined or connected together; the expression “joined” or “connected” should be interpreted broadly so as to include all means of joining or assembling, in particular via adhesive bonding;
“diene” rubber: any elastomer (single elastomer or mixture of elastomers) that results, at least in part (i.e., a homopolymer or a copolymer), from diene monomers, i.e. from monomers bearing two carbon-carbon double bonds, whether the latter are conjugated or non-conjugated.

FIG. 7 represents an example of such a multilayer laminate (20) comprising a multicomposite reinforcer (R-7), consisting of three GRC monofilaments (10a, 10b, 10c) (as depicted in FIG. 1) collectively embedded in their thermoplastic sheath (12), this reinforcer according to the invention R-7 itself being coated with an elastomer sheath (14) for example a diene elastomer sheath, in order to form a multilayer laminate in accordance with the invention.

This light and efficient multilayer laminate, which is resistant to corrosion, makes it possible to advantageously replace, in vehicle tyres, the conventional rubber plies reinforced by conventional textile cords or steel cords.

Owing in addition to the presence of a significant amount of thermoplastic material, this laminate of the invention has the advantage of having a low hysteresis compared to such conventional fabrics. Yet, a major objective of manufacturers of tyres is precisely to lower the hysteresis of the constituents thereof in order to reduce the rolling resistance of these tyres.

Each layer of rubber composition, or hereinbelow “rubber layer”, which is a constituent of the multilayer laminate of the tyre of the invention is based on at least one elastomer, preferably of diene type.

This diene elastomer is preferably selected from the group consisting of polybutadienes (BRs), natural rubber (NR), synthetic polyisoprenes (IRs), various butadiene copolymers, various isoprene copolymers and mixtures of these elastomers, such copolymers being especially selected from the group consisting of butadiene/styrene copolymers (SBRs), isoprene/butadiene copolymers (BIRs), isoprene/styrene copolymers (SIRs) and isoprene/butadiene/styrene copolymers (SBIRs).

One particularly preferred embodiment consists in using an “isoprene” elastomer, that is to say an isoprene homopolymer or copolymer, in other words a diene elastomer selected from the group consisting of natural rubber (NR), synthetic polyisoprenes (IRs), various isoprene copolymers and mixtures of these elastomers. The isoprene elastomer is preferably natural rubber or a synthetic polyisoprene of the cis-1,4 type. Among these synthetic polyisoprenes, use is preferably made of polyisoprenes having a content (mol %) of cis-1,4-bonds of greater than 90%, even more preferably greater than 98%. According to one preferred embodiment, each layer of rubber composition contains 50 to 100 phr of natural rubber. According to other preferred embodiments, the diene elastomer may consist, in full or in part, of another diene elastomer such as, for example, an SBR elastomer used as a blend with another elastomer, for example of the BR type, or used alone.

The rubber composition may contain a single diene elastomer or several diene elastomers, the latter possibly being used in combination with any type of synthetic elastomer other than a diene elastomer, or even with polymers other than elastomers. The rubber composition may also comprise all or some of the additives customarily used in the rubber matrices intended for the manufacture of tyres, such as for example reinforcing fillers such as carbon black or silica, coupling agents, anti-ageing agents, antioxidants, plasticizing agents or extender oils, whether the latter are of aromatic or non-aromatic nature, plasticizing resins with a high glass transition temperature, processing aids, tackifying resins, anti-reversion agents, methylene acceptors and donors, reinforcing resins, a crosslinking or vulcanization system.

Preferably, the system for crosslinking the rubber composition is a system referred to as a vulcanization system, that is to say one based on sulphur (or on a sulphur donor agent) and a primary vulcanization accelerator. Various known vulcanization activators or secondary accelerators may be added to this basic vulcanization system. Sulphur is used at a preferred content of between 0.5 and 10 phr, and the primary vulcanization accelerator, for example a sulphenamide, is used at a preferred content of between 0.5 and 10 phr. The content of reinforcing filler, for example of carbon black or silica, is preferably greater than 50 phr, especially between 50 and 150 phr.

All carbon blacks, in particular blacks of the HAF, ISAF or SAF type, conventionally used in tyres (“tyre-grade” blacks), are suitable as carbon blacks. Among the latter, more particular mention will be made of carbon blacks of 300, 600 or 700 (ASTM) grade (for example N326, N330, N347, N375, N683, N772). Precipitated or fumed silicas having a BET surface area of less than 450 m²/g, preferably from 30 to 400 m²/g, are notably suitable as silicas.

A person skilled in the art will know, in light of the present description, how to adjust the formulation of the rubber composition in order to achieve the desired levels of properties (especially modulus of elasticity), and to adapt the formulation to the specific application envisaged.

Preferably, the rubber composition has, in the crosslinked state, a secant tensile modulus, at 10% elongation, which is between 4 and 25 MPa, more preferably between 4 and 20 MPa; values in particular between 5 and 15 MPa have proved to be particularly suitable for reinforcing the belts of pneumatic tyres. Modulus measurements are carried out in tensile tests, unless otherwise indicated in accordance with the standard ASTM D 412 of 1998 (test specimen “C”): the “true” secant modulus (that is to say the one with respect to the actual cross section of the test specimen) is measured in second elongation (that is to say after an accommodation cycle) at 10% elongation, denoted here by Ms and expressed in MPa (under standard temperature and relative humidity conditions in accordance with the standard ASTM D 1349 of 1999).

According to one preferred embodiment, in the multilayer laminate of the invention, the thermoplastic layer (12) is provided with an adhesive layer facing each layer of rubber composition with which it is in contact.

In order to adhere the rubber to this thermoplastic material, use could be made of any appropriate adhesive system, for example a simple textile adhesive of the “RFL” (resorcinol-formaldehyde-latex) type comprising at least one diene elastomer such as natural rubber, or any equivalent adhesive known for imparting satisfactory adhesion between rubber and conventional thermoplastic fibres such as polyester or polyamide fibres, such as for example the adhesive compositions described in the applications WO 2013/017421, WO 2013/017422, WO 2013/017423.

By way of example, the adhesive coating process may essentially comprise the following successive steps: passage through a bath of adhesive, followed by drainage (for example by blowing, grading) to remove the excess adhesive; then drying, for example by passing into an oven or heating tunnel (for example for 30 s at 180° C.) and finally heat treatment (for example for 30 s at 230° C.).

Before the above adhesive coating process, it may be advantageous to activate the surface of the thermoplastic material, for example mechanically and/or physically and/or chemically, to improve the adhesive uptake thereof and/or the final adhesion thereof to the rubber. A mechanical treatment could consist, for example, of a prior step of matting or scratching the surface; a physical treatment could consist, for example, of a treatment via radiation such as an electron beam; a chemical treatment could consist, for example, of prior passage through a bath of epoxy resin and/or isocyanate compound.

Since the surface of the thermoplastic material is, as a general rule, smooth, it may also be advantageous to add a thickener to the adhesive used, in order to improve the total uptake of adhesive by the multicomposite reinforcer during the adhesive coating thereof.

A person skilled in the art will easily understand that the connection between the thermoplastic polymer layer of the multicomposite reinforcer of the invention and each rubber layer with which it is in contact in the multilayer laminate of the invention is ensured definitively during the final curing (crosslinking) of the rubber article, especially tyre, for which the laminate is intended.

It goes without saying that in all the particular examples of the invention described above and depicted in FIGS. 1 to 7, the GRC monofilaments, of diameter D_{M} and having a circular cross section, could be replaced by GRC monofilaments of different shape, for example having a rectangular (including square) or other (for example oval) cross section, D_{M} then representing, by convention, the diameter known as clearance diameter, that is to say the diameter of the circle circumscribing their cross section.

### 5. EXEMPLARY EMBODIMENTS OF THE INVENTION

Examples of the manufacture of GRC monofilaments that are suitable for the invention, then of multicomposite reinforcers and of multilayer laminates according to the invention based on these GRC monofilaments, and finally the use thereof as reinforcing elements in pneumatic tyres will be described hereinafter.

The GRC monofilaments that are suitable for the invention may be prepared according to a process comprising the following main steps:
creating a rectilinear arrangement of glass fibres (filaments) and conveying this arrangement in a feed direction;
in a vacuum chamber, degassing the arrangement of fibres by the action of the vacuum;
at the outlet of the vacuum chamber, after degassing, passing through an impregnation chamber under vacuum so as to impregnate said arrangement of fibres with a thermosetting resin or resin composition, in the liquid state, in order to obtain a prepreg containing the glass filaments and the resin;
passing said prepreg through a sizing die having a cross section of predefined area and shape, to provide it with a shape of a monofilament (for example a monofilament with a round cross section or a strip with a rectangular cross section);
downstream of the die, in a UV irradiation chamber, polymerizing the resin under the action of the UV rays;
then winding the monofilament obtained in this way, for storage.

All the above steps (arranging, degassing, impregnating, sizing, polymerizing and final winding) are steps which are known to those skilled in the art, as well as the materials (multifilament fibres and resin compositions) used; they have been described, for example, in one and/or the other of the applications EP-A-1 074 369 and EP-A-1 174 250.

It will be recalled especially that before any impregnation of the fibres, an essential step of degassing the arrangement of fibres by the action of the vacuum must be carried out, in order especially to boost the effectiveness of the later impregnation, and above all to guarantee the absence of bubbles within the finished composite monofilament.

After passing through the vacuum chamber, the glass filaments enter an impregnation chamber which is completely full of impregnation resin, and therefore devoid of air: this is how this impregnation step can be described as “impregnation under vacuum”.

The impregnation resin (resin composition) preferably comprises a photoinitiator which is sensitive (reactive) to UV rays above 300 nm, preferably between 300 and 450 nm. This photoinitiator is used at an amount preferably of from 0.5% to 3%, more preferably from 1% to 2.5%. The resin may also comprise a crosslinking agent, for example at an amount of between 5% and 15% (% by weight of impregnation composition).

Preferably, this photoinitiator is from the family of phosphine compounds, more preferably a bis(acyl)phosphine oxide, such as for example bis(2,4,6-trimethylbenzoyl)phenylphosphine oxide (“Irgacure 819” from BASF) or a mono(acyl)phosphine oxide (for example “Esacure TPO” from Lamberti), such phosphine compounds being able to be used in a mixture with other photoinitiators, for example photoinitiators of the alpha-hydroxy ketone type, such as for example dimethylhydroxyacetophenone (e.g. “Esacure KL200” from Lamberti) or 1-hydroxycyclohexyl phenyl ketone (e.g. “Esacure KS300” from Lamberti), benzophenones such as 2,4,6-trimethylbenzophenone (e.g. “Esacure TZT” from Lamberti) and/or thioxanthone derivatives such as, for example, isopropylthioxanthone (e.g. “Esacure ITX” from Lamberti).

The “sizing” die makes it possible, by having a cross section of determined dimensions, generally and preferably circular or rectangular, to adjust the proportion of resin with respect to the glass fibres while at the same time imposing on the prepreg the shape and thickness required for the monofilament.

The polymerization or UV irradiation chamber then has the function of polymerizing and crosslinking the resin under the action of the UV rays. It comprises one or preferably several UV irradiators, each composed for example of a UV lamp with a wavelength of 200 to 600 nm.

The GRC monofilament thus formed through the UV irradiation chamber, in which the resin is now in the solid state, is then recovered for example on a take-up reel, on which it may be wound over a very great length.

Between the sizing die and the final receiving support, it is preferred to keep the tensions to which the glass fibres are subjected at a moderate level, preferably between 0.2 and 2.0 cN/tex, more preferably between 0.3 and 1.5 cN/tex; in order to control this, it will be possible for example to measure these tensions directly at the outlet of the irradiation chamber, by means of suitable tension meters well known to those skilled in the art.

Aside from the known steps described above, the process for manufacturing the GRC monofilament suitable for the invention comprises the following essential steps:
the speed (Sᵢᵣ) of passage of the monofilament through the irradiation chamber is greater than 50 m/min;
the duration (Dᵢᵣ) of passage of the monofilament through the irradiation chamber is equal to or greater than 1.5 s;
the irradiation chamber comprises a tube which is transparent to UV rays (such as a quartz tube or preferably a glass tube), referred to as an irradiation tube, through which the monofilament moves during formation, this tube having a stream of inert gas flowing through it, preferably nitrogen.

If these essential steps are not combined, the improved properties of the monofilament suitable for the invention, in particular Tg₁, elongation A_{(M)} and modulus E_{(M)}, cannot be achieved.

In particular, in the absence of sweeping with an inert gas such as nitrogen in the irradiation tube, it has been observed that the above properties worsened quite quickly during manufacture and thus that industrial performance was no longer guaranteed.

Moreover, if the duration of irradiation Dᵢᵣ of the monofilament in the irradiation chamber is too short (less than 1.5 s), numerous tests revealed (see results in the sole table appended, for tests carried out at different speeds Sᵢᵣ greater than 50 m/min) that either the Tg₁ values were insufficient, at lower than 190° C., or the A_{(M)} values were too low, at lower than 4.0%.

It was also observed that a high speed of irradiation Sᵢᵣ (greater than 50 m/min, preferably between 50 and 150 m/min) was favourable, on the one hand, for an excellent degree of alignment of the glass filaments inside the GRC monofilament, and, on the other hand, for a better retention of the vacuum inside the vacuum chamber, with a significantly reduced risk of having a certain fraction of the impregnation resin coming back from the impregnation chamber towards the vacuum chamber, and therefore for a better quality of impregnation.

The diameter of the irradiation tube (preferably made of glass) is preferably between 10 and 80 mm, preferably between 20 and 60 mm.

Preferably, the speed Sᵢᵣ is between 50 and 150 m/min, more preferably in a range from 60 to 120 m/min.

Preferably, the duration of irradiation Dᵢᵣ is between 1.5 and 10 s, more preferably in a range from 2 to 5 s.

According to another preferred embodiment, the irradiation chamber comprises a plurality of UV irradiators (or radiators), that is to say at least two (two or more than two) which are arranged in a row around the irradiation tube. Each UV irradiator typically comprises one (at least one) UV lamp (preferably emitting in a spectrum from 200 to 600 nm) and a parabolic reflector at the focal point of which is the centre of the irradiation tube; it delivers a linear power density preferably of between 2000 and 14 000 watts per metre. More preferably still, the irradiation chamber comprises at least three, in particular at least four UV irradiators in a row.

Even more preferably, the linear power density delivered by each UV irradiator is between 2500 and 12 000 watts per metre, in particular in a range from 3000 to 10 000 watts per metre.

UV radiators which are suitable for the process of the invention are well known to those skilled in the art, for example those sold by the company Dr. Hönle AG (Germany) under the reference “1055 LCP AM UK”, fitted with “UVAPRINT” lamps (iron-doped high pressure mercury lamps). The nominal (maximum) power of each radiator of this type is equal to approximately 13 000 watts, the power output actually being able to be regulated with a potentiometer between 30% and 100% of the nominal power.

Preferably, the temperature of the resin (resin composition), in the impregnation chamber, is between 50° C. and 95° C., more preferably between 60° C. and 90° C.

According to another preferred embodiment, the conditions of irradiation are adjusted such that the temperature of the GRC monofilament at the outlet of the impregnation chamber is greater than the Tg (Tg₁) of the crosslinked resin; more preferably, this temperature is greater than the Tg (Tg₁) of the crosslinked resin and less than 270° C.

Appended FIG. 8 very simply depicts an example of a device 100 which makes possible the production of GRC monofilaments (10) as depicted in FIG. 1.

In this figure, a reel 110 can be seen, containing, in the example illustrated, glass fibres 111 (in the form of multifilaments). The reel is unwound continuously by conveying so as to produce a rectilinear arrangement 112 of these fibres 111. In general, the reinforcing fibres are delivered in “rovings”, that is to say already in groups of fibres wound in parallel onto a reel; for example, fibres sold by Owens Corning under the fibre name “Advantex” are used, with a count equal to 1200 tex (as a reminder, 1 tex corresponds to 1 g/1000 m of fibre). It is for example the tensioning applied by the turning receiver 126 which will enable the fibres to progress in parallel and enable the GRC monofilament to move along the length of the installation 100.

This arrangement 112 then passes through a vacuum chamber 113 (connected to a vacuum pump, not shown), arranged between an inlet tubing 113a and an outlet tubing 113b which opens into an impregnation chamber 114, the two tubings preferably with rigid walls having, for example, a minimal cross section greater than (typically twice as large as) the total cross section of the fibres and a length very much greater than (typically 50 times greater than) said minimal cross section.

As already taught by the aforementioned application EP-A-1 174 250, the use of tubings with rigid walls both for the inlet opening into the vacuum chamber and for the outlet opening of the vacuum chamber and the transfer from the vacuum chamber to the impregnation chamber proves to be compatible at the same time with high passage rates of the fibres through the openings without breaking the fibres, and also makes it possible to ensure sufficient sealing. All that is required, if need be experimentally, is to find the largest flow cross section, given the total cross section of the fibres to be treated, that will still allow sufficient sealing to be achieved, given the rate of advance of the fibres and the length of the tubings. Typically, the vacuum inside the chamber 113 is, for example, of the order of 0.1 bar, and the length of the vacuum chamber is approximately 1 metre.

On exiting the vacuum chamber 113 and the outlet tubing 113b, the arrangement 112 of fibres 111 passes through an impregnation chamber 114 comprising a feed tank 115 (connected to a metering pump, not depicted) and a sealed impregnation tank 116 completely full of impregnation composition 117 based on a curable resin of the vinyl ester type (e.g. “E-Nova FW 2045” from DSM). By way of example, the composition 117 further comprises (in a weight content of 1 to 2%) a photoinitiator suitable for UV and/or UV-visible radiation with which the composition will subsequently be treated, for example bis(2,4,6-trimethylbenzoyl)phenylphosphine oxide (“Irgacure 819” from BASF). It may also comprise (for example approximately 5% to 15% of) a crosslinking agent such as, for example, tris(2-hydroxyethyl)isocyanurate triacrylate (“SR 368” from Sartomer). Of course, the impregnation composition 117 is in the liquid state.

Preferably, the impregnation chamber is several metres long, for example between 2 and 10 m, in particular between 3 and 5 m.

Thus, a prepreg which comprises for example (in % by weight) from 65 to 75% solid fibres 111, the remainder (25 to 35%) being formed of the liquid impregnation matrix 117, leaves the impregnation chamber 114 in a sealed outlet tubing 118 (still under rough vacuum).

The prepreg then passes through sizing means 119 comprising at least one sizing die 120, the passage of which (not depicted here), for example of circular, rectangular or even conical shape, is suited to the specific embodiment conditions. By way of example, this passage has a minimal cross section of circular shape, the downstream orifice of which has a diameter slightly greater than that of the targeted monofilament. Said die has a length which is typically at least 100 times greater than the minimum dimension of the minimal cross section. Its purpose is to give the finished product good dimensional accuracy, and may also serve to meter the fibre content with respect to the resin. According to one possible alternative form of embodiment, the die 120 can be directly incorporated into the impregnation chamber 114, thereby for example avoiding the need to use the outlet tubing 118.

Preferably, the sizing zone is several centimetres long, for example between 5 and 50 cm, in particular between 5 and 20 cm.

By virtue of the sizing means (119, 120) a “liquid” composite monofilament (121), liquid in the sense that its impregnation resin is still liquid at this stage, is obtained at this stage, the shape of the cross section of which is preferably essentially circular.

At the outlet of the sizing means (119, 120), the liquid composite monofilament (121) obtained in this way is then polymerized by passing through a UV irradiation chamber (122) comprising a sealed glass tube (123) through which the composite monofilament moves; said tube, the diameter of which is typically a few cm (for example 2 to 3 cm), is irradiated by a plurality of (here, for example, 4) UV irradiators (124) in a row (“UVAprint” lamps from Dr. Hönle, with a wavelength of 200 to 600 nm) arranged at a short distance (a few cm) from the glass tube. Preferably, the irradiation chamber is several metres long, for example between 2 and 15 m, in particular between 3 and 10 m. The irradiation tube 123 in this example has a stream of nitrogen flowing through it.

The irradiation conditions are preferably adjusted such that, at the outlet of the impregnation chamber, the temperature of the GRC monofilament measured at the surface thereof (for example by means of a thermocouple) is greater than the Tg (Tg₁) of the crosslinked resin (in other words greater than 190° C.) and more preferably less than 270° C.

Once the resin has polymerized (cured), the GRC monofilament (125) which is now in the solid state and conveyed in the direction of the arrow F then arrives at its final take-up reel (126).

Finally, a finished, manufactured composite block as depicted in FIG. 1 is obtained, in the form of a continuous, very long GRC monofilament (10), the unitary glass filaments (101) of which are distributed homogeneously throughout the volume of cured resin (102). Its diameter is for example equal to around 1 mm. The process described above may be implemented at high speed, preferably greater than 50 m/min, for example between 50 and 150 m/min.

Advantageously, before deposition of the sheath of thermoplastic material (12), the GRC monofilament (10) thus obtained may be subjected to an adhesion treatment in order to improve the subsequent adhesion between the crosslinked resin (102) described above and the thermoplastic sheath (12). A suitable chemical treatment could, for example, consist of a prior passage through an aqueous bath based on epoxy resin and/or isocyanate compound, followed by at least one heat treatment that aims to eliminate the water and polymerize the adhesive layer.

Such adhesion treatments are well known to a person skilled in the art. By way of example, an adhesive coating operation will be carried out by passing through an aqueous bath (around 94% of water) essentially based on epoxy resin (“DENACOL” EX-512 polyglycerol polyglycidyl ether from Nagase ChemteX Corporation, around 1%) and on isocyanate compound (“GRILBOND” IL-6 caprolactam-blocked isocyanate compound from EMS, around 5%), which adhesive coating step is followed by drying (30 s at 185° C.) then a heat treatment (30 s at 200° C.).

Once the GRC monofilament (10) is thus finished and adhesive coated, the latter is sheathed, covered in a known manner with a layer of thermoplastic material (12), for example by passing the monofilament, or even where appropriate several monofilaments positioned in parallel, through an appropriate extrusion head delivering the thermoplastic material in the molten state.

The step of sheathing or covering with the thermoplastic material (12) is carried out in a manner known by those skilled in the art. For example it consists simply in passing the or each GRC monofilament through one or more dies of suitable diameter, through extrusion heads heated to suitable temperatures, or else through a coating bath containing the thermoplastic material previously dissolved in a suitable organic solvent (or mixture of solvents).

By way of example, covering a GRC monofilament having a diameter of approximately 1 mm with a layer of PET of minimal thickness Eₘ equal to around 0.2 mm, in order to obtain a multicomposite reinforcer having a total diameter of around 1.4 mm, is carried out on an extrusion/sheathing line comprising two dies, a first die (counter-die or upstream die) having a diameter equal to around 1.05 mm and a second die (or downstream die) having a diameter equal to around 1.45 mm, both dies being positioned in an extrusion head brought to around 290° C.

The PET (“Artenius Design+” from Artenius; Tg₂ equal to around 76° C.; Tm equal to around 230° C.) melts at a temperature of 280° C. in the extruder, thus covers the GRC monofilament, via the sheathing head, at a thread run speed typically equal to several tens of m/min, for an extrusion pump flow rate typically of several tens of cm³/min. On exiting this first sheathing operation, the thread may be immersed in a cooling tank filled with cold water, in order to solidify and set the polyester in its amorphous state, then dried for example in-line by an air nozzle, or by passing the take-up reel into the oven.

On exiting the extrusion head, the filament(s) thus sheathed are then cooled sufficiently so as to solidify the layer of thermoplastic material, for example with air or another cold gas, or by passing through a water bath, followed by a drying stage.

The multicomposite reinforcer of the invention thus obtained, as depicted for example in the FIG. 2b, has the following final properties: D_{M} equal to around 1.0 mm; Eₘ equal to around 0.2 mm; D_{R} equal to around 1.4 mm; Tg₁ equal to around 205° C.; Tg₂ equal to around 76° C.; A_{(M)} equal to around 4.5%; E_{(M)} equal to around 43 GPa; E_{(R)} equal to around 14 GPa; E′_{190(M)} equal to around 37 GPa; E′_{(Tg1-25)}/E′_{20(M)} equal to around 0.92; compressive elastic deformation in bending of the monofilament equal to around 3.6%; compressive breaking stress in bending of the monofilament equal to around 1350 MPa; weight content of glass fibres in the monofilament equal to around 70%; initial tensile modulus of the crosslinked vinyl ester resin, at 20° C., equal to around 3.6 GPa; initial tensile modulus of the PET (at 20° C.) equal to around 1100 MPa.

The multicomposite reinforcer of the invention manufactured in this way can advantageously be used, especially in the form of a multilayer laminate in accordance with the invention, for reinforcing pneumatic or non-pneumatic tyres of all types of vehicles, in particular passenger vehicles or industrial vehicles such as heavy vehicles, civil engineering vehicles, aircraft and other transport or handling vehicles.

As an example, FIG. 9 illustrates, highly schematically (without being true to a specific scale) a radial section through a pneumatic tyre, that is or is not in accordance with the invention in this general representation.

This pneumatic tyre 200 comprises a crown 202 reinforced by a crown reinforcement or belt 206, two sidewalls 203 and two beads 204, each of these beads 204 being reinforced with a bead wire 205. The crown 202 is surmounted by a tread, not shown in this schematic figure. A carcass reinforcement 207 is wound around the two bead wires 205 in each bead 204, the turn-up 208 of this reinforcement 207 being, for example, positioned towards the outside of the tyre 200, which is here represented fitted onto its wheel rim 209. Of course, this pneumatic tyre 200 additionally comprises, in a known way, a layer of rubber 201 commonly referred to as an airtight rubber or layer, which defines the radially inner face of the tyre and which is intended to protect the carcass ply from the diffusion of air originating from the space interior to the pneumatic tyre.

The carcass reinforcement 207, in the tyres of the prior art, is generally formed from at least one rubber ply reinforced by what are referred to as “radial” textile or metal reinforcers, that is to say these reinforcers are arranged practically parallel to one another and extend from one bead to the other to form an angle of between 80° and 90° with the median circumferential plane (plane perpendicular to the axis of rotation of the tyre, which is situated halfway between the two beads 204 and passes through the middle of the crown reinforcement 206).

The belt 206 is for example formed, in the tyres of the prior art, of at least two superposed and crossed rubber plies known as “working plies” or “triangulation plies”, reinforced with metal cords positioned substantially parallel to one another and inclined relative to the median circumferential plane, it being possible for these working plies to optionally be combined with other rubber fabrics and/or plies. The primary role of these working plies is to give the pneumatic tyre a high cornering stiffness. The belt 206 may also comprise, in this example, a rubber ply referred to as a “hooping ply”, reinforced by what are referred to as “circumferential” reinforcing threads, that is to say these reinforcing threads are arranged practically parallel to one another and extend substantially circumferentially around the pneumatic tyre so as to form an angle preferably within a range from 0 to 10° with the median circumferential plane. The role of these reinforcing threads is in particular to withstand the centrifugation of the crown at high speed.

A pneumatic tyre 200, when it is in accordance with the invention, has the preferential feature that at least its belt (206) and/or its carcass reinforcement (207) comprises a multilayer laminate according to the invention, consisting of at least one multicomposite reinforcer according to the invention positioned between and in contact with two layers of diene rubber composition. According to one particular embodiment of the invention, this multicomposite reinforcer of the invention may be used in the form of parallel sections positioned under the tread, as described in the aforementioned patent EP 1 167 080. According to another possible exemplary embodiment of the invention, it is the bead zone that may be reinforced with such a multicomposite reinforcer; it is for example the bead wires (205) that could be formed, in whole or in part, of a multicomposite reinforcer according to the invention.

In these examples from FIG. 9, the rubber compositions used for the multilayer laminates according to the invention are for example conventional compositions for calendering textile reinforcers, typically based on natural rubber, carbon black or silica, a vulcanization system and the usual additives. By virtue of the invention, compared to rubber compositions reinforced with steel cords, the compositions may advantageously have no metal salts such as cobalt salts. The adhesion between the multicomposite reinforcer of the invention and the rubber layer that coats it may be provided in a simple and known manner, for example by a standard adhesive of RFL (resorcinol-formaldehyde-latex) type, or with the aid of more recent adhesives as described for example in the aforementioned applications WO 2013/017421, WO 2013/017422, WO 2013/017423.

Specific tests on pneumatic tyres were carried out in which multicomposite reinforcers according to the invention as manufactured above were used as longilineal reinforcers, that is to say non-cabled reinforcers, in crossed working plies instead of conventional steel cords, as described in the aforementioned document EP 1 167 080. These tests clearly demonstrated that the multicomposite reinforcers of the invention, by virtue of their improved properties in compression, did not undergo breakages in compression during the very manufacturing of these pneumatic tyres, unlike the GRC monofilaments of the prior art such as those described in EP 1 167 080.

While significantly lightening the pneumatic tyres and removing the risks associated with corrosion compared to tyres with a belt reinforced in the conventional way with steel cords, the multicomposite reinforcers of the invention also revealed the other significant advantage of not increasing the rolling noise of the pneumatic tyres, unlike other known textile (reinforcer) solutions. These multicomposite reinforcers of the invention also demonstrated excellent performance as circumferential reinforcers in non-pneumatic tyres such as those described in the introduction of this document.

In conclusion, there are many advantages of the multilayer laminate and of the multicomposite reinforcer of the invention (small thickness, low density, low cost, resistance to corrosion) compared to conventional metallic fabrics, and the results obtained owing to the invention (in particular improved properties in compression) offer them a very large number of possible applications, especially as an element for reinforcing the belt of tyres, positioned between the tread and the carcass reinforcement.

The invention also relates to any finished article or semi-finished product made of plastic or rubber comprising a multicomposite reinforcer or a multilayer laminate in accordance with the invention. The invention relates more particularly to a pneumatic or non-pneumatic tyre, the multicomposite reinforcer or the multilayer laminate being present in the belt of the tyre or in the carcass reinforcement of the tyre, or in the bead zone of the tyre.

TABLE

| | | |
|---|---|---|
| Dᵢᵣ (s) | Tg₁ (° C.) | A_{(M)} (%) |

Test 1

| | | |
|---|---|---|
| 1.2 | 186.1 | 3.4 |
| 1.3 | 188.8 | 3.8 |
| 1.45 | 189.1 | 3.9 |
| 1.7 | 194.8 | 4.3 |
| 2.0 | 195.7 | 4.5 |

Test 2

| | | |
|---|---|---|
| 1.5 | 190.0 | 4.0 |
| 1.65 | 192.7 | 4.1 |
| 1.8 | 195.0 | 4.1 |
| 2.0 | 199.2 | 4.3 |

Test 3

| | | |
|---|---|---|
| 2.0 | 192.8 | 4.3 |
| 2.4 | 193.7 | 4.5 |
| 3.0 | 196.9 | 4.6 |
| 4.0 | 195.0 | 4.7 |

Test 4

| | | |
|---|---|---|
| 1.0 | 184.7 | 4.3 |
| 1.2 | 187.3 | 4.2 |
| 1.6 | 190.5 | 4.2 |
| 2.0 | 200.5 | 4.3 |

1.-29. (canceled)

30. A multicomposite reinforcer comprising one or more monofilaments made of glass-resin composite comprising glass filaments embedded in a crosslinked resin, the glass transition temperature of which is denoted Tg₁,
wherein a layer of a thermoplastic material, the glass transition temperature of which, denoted Tg₂, is greater than 20° C., covers said one or more monofilaments individually or collectively covers all or at least some of the one or more monofilaments;
wherein all or at least some of said one or more monofilaments have a temperature Tg₁ equal to or greater than 190° C., an elongation at break, denoted A_{(M)}, measured at 20° C., equal to or greater than 4.0%, and an initial tensile modulus, denoted E_{(M)}, measured at 20° C., greater than 35 GPa.

31. The multicomposite reinforcer according to claim 30, wherein Tg₁ is greater than 195° C.

32. The multicomposite reinforcer according to claim 31, wherein Tg₁ is greater than 200° C.

33. The multicomposite reinforcer according to claim 30, wherein Tg₂ is greater than 50° C.

34. The multicomposite reinforcer according to claim 33, wherein Tg₂ is greater than 70° C.

35. The multicomposite reinforcer according to claim 30, wherein A_{(M)} is greater than 4.2%.

36. The multicomposite reinforcer according to claim 35, wherein A_{(M)} is greater than 4.4%.

37. The multicomposite reinforcer according to claim 30, wherein E_{(M)} is greater than 40 GPa.

38. The multicomposite reinforcer according to claim 37, wherein E_{(M)} is greater than 42 GPa.

39. The multicomposite reinforcer according to claim 30, wherein all or at least some of said one or more monofilaments have a real part of the complex modulus, denoted E′_{190(M)}, measured at 190° C. by the DMTA method, which is greater than 30 GPa.

40. The multicomposite reinforcer according to claim 39, wherein E′_{190(M)} is greater than 33 GPa.

41. The multicomposite reinforcer according to claim 40, wherein E′_{190(M)} is greater than 36 GPa.

42. The multicomposite reinforcer according to claim 30, wherein a ratio E′_{(Tg2′-25)(M)}/E′_{20(M)} is greater than 0.85, where E′_{20(M)} and E′_{(Tg2′-25)(M)} are the real part of the complex modulus of all or at least some of said one or more monofilaments, measured by DMTA, respectively at 20° C. and at a temperature expressed in ° C. equal to (Tg₂′−25), where Tg₂′ is the glass transition temperature of the resin measured by DMTA.

43. The multicomposite reinforcer according to claim 42, wherein the ratio E′_{(Tg2′-25)(M)}/E′_{20(M)} is greater than 0.90.

44. The multicomposite reinforcer according to claim 30, wherein a ratio E′_{(Tg2′-10)(M)}/E′_{20(M)} is greater than 0.80, where E′_{20(M)} and E′_{(Tg2′-10)(M)} are the real part of the complex modulus of all or at least some of the one or more monofilaments, measured by DMTA, respectively at 20° C. and at a temperature expressed in ° C. equal to (Tg₂′−10), where Tg₂′ is the glass transition temperature of the resin measured by DMTA.

45. The multicomposite reinforcer according to claim 44, wherein a ratio E′_{(Tg2′-10)(M)}/E′_{20(M)} is greater than 0.85.

46. The multicomposite reinforcer according to claim 30, wherein all or at least some of the one or more monofilaments have a compressive elastic deformation in bending which is greater than 3.0%.

47. The multicomposite reinforcer according to claim 46, wherein all or at least some of the one or more monofilaments have a compressive elastic deformation in bending which is greater than 3.5%.

48. The multicomposite reinforcer according to claim 30, wherein all or at least some of the one or more monofilaments have a compressive breaking stress in bending which is greater than 1000 MPa.

49. The multicomposite reinforcer according to claim 48, wherein all or at least some of the one or more monofilaments have a compressive breaking stress in bending which is greater than 1200 MPa.

50. The multicomposite reinforcer according to claim 30, wherein all or at least some of the one or more monofilaments have a weight content of glass filaments that is between 60% and 80%.

51. The multicomposite reinforcer according to claim 50, wherein all or at least some of the one or more monofilaments have a weight content of glass filaments that is between 65% and 75%.

52. The multicomposite reinforcer according to claim 30, wherein all or at least some of the one or more monofilaments have a density which is between 1.8 and 2.1 g/cm³.

53. The multicomposite reinforcer according to claim 30, wherein the crosslinked resin of all or at least some of the one or more monofilaments is a vinyl ester resin.

54. The multicomposite reinforcer according to claim 30, wherein the crosslinked resin of all or at least some of the one or more monofilaments have an initial tensile modulus, measured at 20° C., which is greater than 3.0 GPa.

55. The multicomposite reinforcer according to claim 54, wherein the crosslinked resin of all or at least some of the one or more monofilaments have an initial tensile modulus, measured at 20° C., which is greater than 3.5 GPa.

56. The multicomposite reinforcer according to claim 30, wherein a diameter, denoted D_{M}, of said one or more monofilaments is between 0.2 and 2.0 mm.

57. The multicomposite reinforcer according to claim 56, wherein the diameter of said one or more monofilaments is between 0.3 and 1.5 mm.

58. The multicomposite reinforcer according to claim 30, wherein a minimal thickness, denoted Eₘ, of the layer of thermoplastic material is between 0.05 and 0.5 mm.

59. The multicomposite reinforcer according to claim 58, wherein the minimal thickness of the layer of thermoplastic material is between 0.1 and 0.4 mm.

60. The multicomposite reinforcer according to claim 30, wherein the thermoplastic material is a polymer or a polymer composition.

61. The multicomposite reinforcer according to claim 60, wherein the polymer is selected from the group consisting of polyamides, polyesters, polyimides and mixtures thereof.

62. The multicomposite reinforcer according to claim 61, wherein the polymer is selected from the group consisting of polyesters, polyetherimides and mixtures thereof.

63. The multicomposite reinforcer according to claim 30, wherein an initial tensile modulus of the thermoplastic material, measured at 20° C., is between 500 and 2500 MPa.

64. The multicomposite reinforcer according to claim 63, wherein the initial tensile modulus of the thermoplastic material, measured at 20° C., is between 500 and 1500 MPa.

65. The multicomposite reinforcer according to claim 30, wherein an elastic elongation of the thermoplastic material, measured at 20° C., is greater than 5%.

66. The multicomposite reinforcer according to claim 65, wherein the elastic elongation of the thermoplastic material, measured at 20° C., is greater than 8%.

67. The multicomposite reinforcer according to claim 30, wherein an elongation at break of the thermoplastic material, measured at 20° C., is greater than 10%.

68. The multicomposite reinforcer according to claim 67, wherein the elongation at break of the thermoplastic material, measured at 20° C., is greater than 15%.

69. The multicomposite reinforcer according to claim 30, wherein the multicomposite reinforcer has an elongation at break denoted A_{(R)}, measured at 20° C., of equal to or greater than 3.0%.

70. The multicomposite reinforcer according to claim 69, wherein the multicomposite reinforcer has an elongation at break denoted A_{(R)}, measured at 20° C., of equal to or greater than 3.5%.

71. The multicomposite reinforcer according to claim 30, wherein the multicomposite reinforcer has an initial tensile modulus denoted E_{(R)}, measured at 20° C., of greater than 9 GPa.

72. The multicomposite reinforcer according to claim 71, wherein the multicomposite reinforcer has an initial tensile modulus denoted E_{(R)}, measured at 20° C., of greater than 12 GPa.

73. A multilayer laminate comprising a multicomposite reinforcer according to claim 30 positioned between and in contact with two layers of a rubber composition.

74. A finished article or semi-finished product made of plastic or of rubber comprising a multicomposite reinforcer according to claim 30.

75. A pneumatic or non-pneumatic tire comprising a multicomposite reinforcer according to claim 30.

76. The pneumatic or non-pneumatic tire according to claim 75, wherein the multicomposite reinforcer is present in the belt or the carcass reinforcement of the pneumatic or non-pneumatic tire.

77. The pneumatic or non-pneumatic tire according to claim 75, wherein the multicomposite reinforcer is present in the bead zone of the pneumatic or non-pneumatic tire.

78. A finished article or semi-finished product made of plastic or of rubber comprising a multilayer laminate according to claim 73.

79. A pneumatic or non-pneumatic tire comprising a multilayer laminate according to claim 73.

80. The pneumatic or non-pneumatic tire according to claim 79, wherein the multilayer laminate is present in the belt or the carcass reinforcement of the pneumatic or non-pneumatic tire.

81. The pneumatic or non-pneumatic tire according to claim 79, wherein the multilayer laminate is present in the bead zone of the pneumatic or non-pneumatic tire.
